(19) United States
(12) Patent Application Publication
(10) Pub. No.: US 2009/0126216 A1
(43) Pub. Date: May 21, 2009

(54) Centrifugal Pellet Dryer Screen

(75) Inventors: Michael Eloo, Xanten (DE); J. Wayne Martin, Buchanan, VA (US); Roger B. Wright, Staunton, VA (US)

Correspondence Address: JACOBSON HOLMAN PLLC, 400 SEVENTH STREET N.W., SUITE 600, WASHINGTON, DC, 20004, US

(73) Assignee: GAIA INDUSTRIES, INC., EAGLE ROCK, VA (US)

(21) Appl. No.: 11/793,691

(22) PCT Filed: Dec. 20, 2005
(86) PCT No.: PCT/US05/46020

§ 371 Date: Apr. 1, 2008

(30) Foreign Application Priority Data
Dec. 21, 2004 (US) 11/017216

(51) Int. Cl. F26B 17/24; B01D 39/10; B04B 1/06

(52) U.S. Cl. 34/58; 210/499; 494/76

(57) ABSTRACT

A centrifugal pellet dryer screen (540) especially adapted for drying polymer pellets and micropellets includes an exterior or outer support screen (542), an inner screen (546) of an irregular or rough surface, and an optional middle screen(s) (544) sandwiched between the outer support screen and the inner screen. The screen layers are in intimate contact and the multi-layer screen assembly produces drier pellets and micropellets exiting the dryer. Plugging of the dryer screens and banding of the pellets or micropellets are significantly reduced.

This patent application is a continuation-in-part of U.S. patent application Ser. No. 11/017,216 filed Dec. 21, 2004, owned by the same assignee as the instant application.

### BACKGROUND OF INVENTION

1. Field of the Invention

The present invention relates generally to screens incorporated into a centrifugal pellet dryer for drying pellets produced by an underwater, strand, water ring or similar pelletizer that enter the dryer as a water and pellet slurry. More specifically, the present invention relates to centrifugal pellet dryers and dryer screens particularly useful for drying polymer pellets and micropellets.

The dryer screens of this invention include an exterior or outer support screen or plate, an optional middle screen or screens, and an inner screen. The outer support plate, middle and inner screens are in intimate contact. The screens are supported in a centrifugal pellet dryer and function in a manner similar to that disclosed in U.S. Pat. Nos. 4,447,325 (May 8, 1984), 5,265,347 (Nov. 30, 1993), 6,237,244 (May 29, 2001), and 6,739,457 (May 25, 2004) having common ownership with this application and which are expressly incorporated herein by reference as if fully set forth.

2. Description of Prior Art

Much reference has been made to the use of screens, particularly multiple layer screens, in filtration of underground oil, purification of coal, for use in vibratory equipment, and especially for fines removal. Arrangement of the screen layers has been used to facilitate cleaning of the screens, to entrap fines recoverably especially from middle layers of the screens, and to control particulate levels in the filtrate or fluid passing through the screens.

Prior art centrifugal pellet dryers utilizing a mesh type screen or perforated plate type screen operate effectively when the pellets being dried have a diameter substantially greater than micropellets. Typical prior art screens are self-supporting single sheets generally in the form of a cylindrical screen sheet or plate with either circular holes or slotted holes. The screen sheet or plate is typically perforated in a flat condition and then rolled into the cylindrical screen shape.

One typical embodiment of a prior art dryer screen having round holes 0.075 inches (1.9 mm) in diameter produced a 50% open area, while still remaining self-supporting. Efforts to form smaller holes by punching the sheet metal resulted in the punches which form the holes breaking off. The smallest diameter hole that can be successfully punched is generally in the range of 0.062 inch ( 1/16 inch) but the use of such small punches reduces the open area to well below 50%. Such known prior art screens also tend to plug up and essentially form a smooth internal surface with very little drag on the pellets engaging the interior of the screen. The smooth surface causes the pellets to move or band in a circular path rather than moving axially upwardly and radially under the action of the inclined blades of the driving rotor in the dryer.

As used herein throughout this specification, the term “open area” is defined as that area of the screen which is open for water, moisture, or air to flow therethrough.

There are known prior art screens for use in drying polymer micropellets produced in pelletizers including underwater, water ring, strand, or hot face, for example. Polymer micropellets are very small thermoplastic or other polymer pellets, having a diameter or outside dimension typically less than 0.050 inches (1.3 mm). In known screens for drying such micropellets, the sheet or plate is formed into a cylindrical shape with the holes formed therein, such as by laser cutting or the like. Laser-perforating the holes, however, results in a very smooth interior surface, thus exacerbating the problem of the pellets simply rotating around the interior of the screen without moving upwardly therein, and thereby increasing the tendency of the screen holes or perforations to become plugged by pellets.

When round holes are used in the prior art polymer micropellet screens, such as in a 22 gauge screen, the holes preferably are approximately 0.40 mm in diameter which produces a retained open area of only about 8.5%. When slotted holes are used, the 22 gauge screen is formed with slots that are typically 0.40 mm in height and 4 mm in length which provides approximately a 14% open area. However, screens with slotted holes tend to crack or tear during use in the centrifugal dryer.

Drying polymer micropellets in centrifugal dryers has become very difficult using known prior art screens. Because polymer micropellets have a tendency to band around the inner surface of the cylindrical screen, especially when the inner surface is smooth or otherwise not interrupted, the micropellets simply circulate around the inside of the screen, plugging the screen holes, and do not move axially upward with rotation of the dryer rotor. The micropellets move up only through the forced introduction of more micropellets into the dryer inlet. As a result, centrifugal pellet dryers with prior art screens have heretofore been generally ineffective in drying polymer micropellets. Hence, there is a need for a centrifugal dryer screen which will overcome the banding and plugging problems and provide for effective drying of polymer micropellets in a centrifugal dryer.

The additional prior U.S. patents and U.S. published patent applications which may be pertinent to the present invention are as follows:

U.S. Patents

| Re. 28,470 | Jul. 8, 1975 |
|---|---|
| 4,126,560 | Nov. 21, 1978 |
| 4,290,889 | Sep. 22, 1981 |
| 4,293,414 | Oct. 6, 1981 |
| 4,295,918 | Oct. 20, 1981 |
| 5,076,875 | Dec. 31, 1991 |
| 5,145,729 | Sep. 8, 1992 |
| 5,182,008 | Jan. 26, 1993 |
| 5,411,084 | May 2, 1995 |
| 5,915,566 | Jun. 29, 1999 |
| 6,510,947 | Jan. 29, 2003 |
| 6,514,408 | Feb. 4, 2003 |
| 6,573,314 | Jun. 3, 2003 |
| 6,715,300 | Apr. 6, 2004 |
| 6,894,109 | May 17, 2005 |

U.S. Published Patent Applications

| | |
|---|---|
| 20040044111 | Mar. 4, 2004 |
| 20050126779 | Jun. 16, 2005 |

### SUMMARY OF THE INVENTION

The dryer screen constructed in accordance with the present invention comprises a dryer screen of two or more layers including an outer cylindrical support screen and an inner screen having irregular surfaces. A middle screen or screens can be sandwiched between the inner screen and the outer support screen depending upon the application.

The outer support screen is typically a foraminous membrane formed from plastic, wire-reinforced plastic, or sheet metal which has been molded or forged, pierced or perforated by punching, laser-cutting or the like to form the holes therein which may be round, square, rectangular, triangular, hexagonal, octagonal or similarly suitable effective geometry.

Alternatively, the outer foraminous membrane may be a structural assembly of plastic, wire-reinforced plastic, or metal wires, bars or rods which may be round, square, rectangular, triangular, wedge-shaped, hexagonal, or of similar multi-dimensional geometry. These components are interwoven or adhered together in a grid-like manner with similar or different geometries as delineated above to generate the screen structure by thermal bonding, chemical bonding, resistance welding, sintering, diffusion bonding, or by any suitably similar assembly techniques known to those skilled in the art.

Preferably, the thickness of the outer support screen is between 18 gauge (about 0.05 inches) and 22 gauge (about 0.0312 inches), and most preferably about 20 gauge (0.0375 inches). Stainless steel sheet material has been found most suitable for the present invention. Preferably, the holes or openings are round perforations having a hole size of at least about 0.075 inches in diameter. The open area of the outer support screen should be at least about 30%, and preferably about 50%, or more.

The inner screen and optional middle screen or screens may have the structure and be made by any of the techniques described above for the outer support screen. The individual screens may be similar or different in structure and composition and may be the same or different in percent open area, i.e., the portion of the screen through which fluid, air, and smaller diameter materials may pass unobstructedly. The open area geometries of the individual screens may be oriented laterally, longitudinally, or rotationally relative to the other screen layers.

Preferably, the inner screen and optional middle screen or screens are a woven wire screen which may be in a square, rectangular, plain, Dutch or similar weave. While the warp and weft wire diameters may differ dimensionally and compositionally, the inner and middle screen or screens are preferably a plain square or rectangular weave screen wherein the warp and weft wires are of the same size and made of the same material. The percent open area is preferably 30% or greater. Most preferably, the inner screen and optional middle screen or screens are 30 mesh grade 304 or grade 316 stainless steel, wherein the warp and weft wires are of a size to allow at least 30% open area and, most preferably, at least 50% open area, or more.

The adjacent screens are in intimate contact and may remain unbound or may have their surfaces bonded together, preferably bonded together. Bonding of the surfaces may be achieved by chemical or thermal adhesion, locally by spot welding or brazing, resistance welded, or preferably they may be diffusion bonded or sintered at all adjacent contact points throughout their surface areas. This attaching mechanism reduces the tendency of the inner screen and/or middle screens to slip or wrinkle with respect to the outer supporting screen or plate during use in the operation of the centrifugal dryer.

It has been surprisingly found that the multi-layer dryer screens of the present invention can have very small inner screen openings that will retain the small polymer micropellets within the screen enclosure. At the same time, the multi-layer dryer screens of the present invention provide a high percentage of open area to allow water, air, and/or fines to pass out of the dryer screen at a higher rate. Typically, the open area is of the multilayer dryer screens in accordance with the present invention should have an open area of about 30%, or more.

It has also been found that irregular surfaces on the middle screen or screens and particularly on the inner screen cause the pellets to bounce radially inwardly in a random fashion when impacting against the inner surface of the screen. This random inward movement or bouncing of the pellets allows the rotating inclined blades on the rotor to more effectively elevate the pellets and to more effectively direct the pellets outwardly for continued impacting engagement with the irregular surfaces of the inner screen. This recirculation of the pellets radially inwardly and outwardly in relation to the screen produces a more effective removal of surface water or moisture from the pellets and discharge of such moisture through the screen, while retaining the pellets or micropellets interiorly of the screen and moving the pellets axially upwardly within the screen.

Additionally, it has been found that the orientation of the irregularities of the middle screen or screens and particularly of the inner screen facilitates the sweeping action of the rotor and lifter blades to aid in moving the pellets and especially micropellets from the surface of the screens. This movement of the pellets leads to a reduction in banding of the pellets and clogging of the screens which otherwise occurs by entrapment of the pellets physically within the screen or by action of the water and pellet slurry against the pellets on the irregular screen surface.

In addition, the multi-layer dryer screens of the present invention result in drier polymer micropellets, i.e. less surface moisture, upon exiting the centrifugal dryer. While intending not to be bound by any theoretical explanation, it is believed that the drier micropellets exiting the dryer are a direct result of the irregular surface of the dryer inner screen, which produces a more effective removal of the surface water or moisture from the pellets, and the high percentage of screen open area in the neighborhood of 30%, as stated above. The high percentage of open area permits a greater volume of air to flow into the top of the dryer and/or the pellet discharge outlet, and then through the screen. This increased air flow further assists in removing the surface water or moisture from the pellets as they rise inside the screen and air flows through the pellets entrained therein.

Accordingly, it is an object of the present invention to provide a screen assembly for a centrifugal pellet dryer especially useful for drying polymer pellets and micropellets which includes an outer support screen or plate combined with at least one inner screen; the inner screen has openings appropriate to the diameter of the polymer pellets to be retained within the interior of the screen while enabling passage of surface water or moisture and fines from the pellets out through the screen during rotation of the dryer rotor.

A further object of the present invention is to provide a multi-layer dryer screen in accordance with the preceding object which dries the pellets, especially polymer micropellets, to a lower percentage of moisture when they are discharged from the centrifugal dryer.

Another object of the present invention is to provide a polymer pellet and micropellet screen for a centrifugal dryer in which the inner screen is provided with an irregular, rough interior surface to cause random radial movement of the micropellets for more effective removal of moisture, and to eliminate the tendency of polymer pellets, especially micropellets, to band and move in generally a circular path around an otherwise smooth surface on the interior screen surface.

Still a further object of the present invention is to provide a dryer screen in accordance with the preceding object in which the plugging of the screen openings is substantially reduced as a result of the irregular, rough interior surface of the inner screen and is further enhanced by the orientation of open area geometry of the inner screen.

Still another object of the present invention is to provide a dryer screen in accordance with the preceding objects in which the screen includes a plurality of screens having a high percent open area to provide maximum air flow from the top of the dryer and/or pellet discharge opening through the pellets and screen for a more effective drying of the pellets during their movement upwardly within the screen enclosure.

Yet a further object of the present invention is to provide a multi-layered dryer screen in which the screen layers are diffusion bonded or sintered at all contact points throughout their full surface areas to reduce the tendency of the inner screen to slip or wrinkle during operation of the centrifugal dryer.

Yet another object of the present invention is to provide a multi-layered dryer screen in which the inner surface of the inner screen is irregular, rough, undulated, or provided with ridges and valleys to reduce the tendency of pellets, especially polymer micropellets, to band along the inner surface in a circular path rather than moving axially upwardly and radially inwardly and outwardly by the inclined blades on the dryer rotor.

A final object of this invention to be specifically enumerated herein, is to provide a multi-layered dryer screen in accordance with the preceding objects which will conform to conventional forms of manufacture, be of simple construction and easy to use so as to provide a centrifugal pellet dryer screen that will be economically feasible, strong and long lasting, and relatively trouble free for installation and use.

These together with other objects and advantages which will become subsequently apparent reside in the details of construction and operation as more fully hereinafter described and claimed, reference being made to the accompanying drawings forming a part hereof, wherein like numerals refer to like parts throughout.

### BRIEF DESCRIPTION OF THE DRAWINGS

FIG. 1 is a schematic side-elevational view of one type of existing centrifugal pellet dryer, similar to FIG. 6 in U.S. Pat. No. 6,237,244, illustrating one application of a dryer screen according to the present invention associated with the operational components of the dryer.

FIG. 2 is a side elevational view of the centrifugal pellet dryer of FIG. 1 and similar to FIG. 3 in U.S. Pat. No. 6,237,244, illustrating the dryer screen according to the present invention relationally associated with the lifted operational components of the dryer.

FIG. 3 is a vertical sectional view, on an enlarged scale, illustrating specific structural details of another type of existing centrifugal pellet dryer, similar to FIG. 3 in U.S. Pat. No. 5,265,347, for a dryer screen according to the present invention.

FIG. 4 is a perspective view of a hinged construction, similar to FIG. 7 in U.S. Pat. No. 5,265,347, used operationally in association with the dryer shown in FIG. 3 for a dryer screen according to the present invention.

FIG. 5 is a schematic elevational view of another type of existing centrifugal pellet dryer, similar to FIG. 1 in U.S. Pat. No. 6,739,457, illustrating a sectional cylindrical dryer screen according to the present invention associated with the operational components of the dryer.

FIG. 6 is an elevational view of a dewatering screen similar to FIG. 1 of U.S. Pat. No. 4,447,325, optionally used with dryers included in this invention, such as illustrated in FIG. 5, which dewatering screen can be made in accordance with the present invention.

FIG. 7 is a transverse sectional view taken substantially through a plane indicated by sectional, line B-B in FIG. 6.

FIG. 8 is a plan view of one of the screen sections shown in FIG. 5, made in accordance with the present invention and illustrating the outside surface of the screen in a flat condition prior to it being formed into a cylindrical screen section and showing the mounted deflector bars.

FIG. 9 is an edge view of the screen section illustrated in FIG. 8.

FIG. 10 is a sectional view, on an enlarged scale, taken along section line A-A on FIG. 8, illustrating the structure on one of the deflector strips and its mating mounting strip including their association with the screen and the fastening structure for securing the strips to the screen.

FIG. 11 is a plan view of one of the screen sections shown in FIG. 5, made in accordance with the present invention and illustrating the outside surface of the screen in a flat condition prior to it being formed into a cylindrical screen section which does not use deflector bars.

FIG. 12 is an edge view of the screen section illustrated in FIG. 11.

FIG. 13a, 13b, 13c, 13d, 13e, and 13f are schematic views of exemplary configurations of various three layer screen constructions made in accordance with the present invention.

FIGS. 14a, 14b, 14c, and 14d are schematic views of exemplary configurations of various two layer screen constructions made in accordance with the present invention.

FIG. 15 is a fragmental elevational view of a segment of a 3-layer micropellet dryer screen constructed in accordance with the present invention and viewed from the outer support screen.

FIG. 16 is a sectional view taken along line C-C of FIG. 15 showing an outer support screen, a middle wire mesh screen, and an inner wire mesh screen of different mesh size, more particularly a larger mesh size or smaller opening size, as shown.

FIG. 17 is a sectional view similar to FIG. 16, but illustrating a 2-layer screen having an outer support screen and an inner wire mesh screen.

### DETAILED DESCRIPTION OF THE INVENTION

Although several preferred embodiments of the invention are explained in detail, it is to be understood that the invention is not limited in its scope to the details of construction and arrangement of components set forth in the following description or illustrated in the drawings. The invention is capable of other embodiments and of being practiced or carried out in various ways. Also, in describing preferred embodiments, specific terminology will be resorted to for the sake of clarity. It is to be understood that each specific term includes all technical equivalents which operate in a similar manner to accomplish a similar purpose.

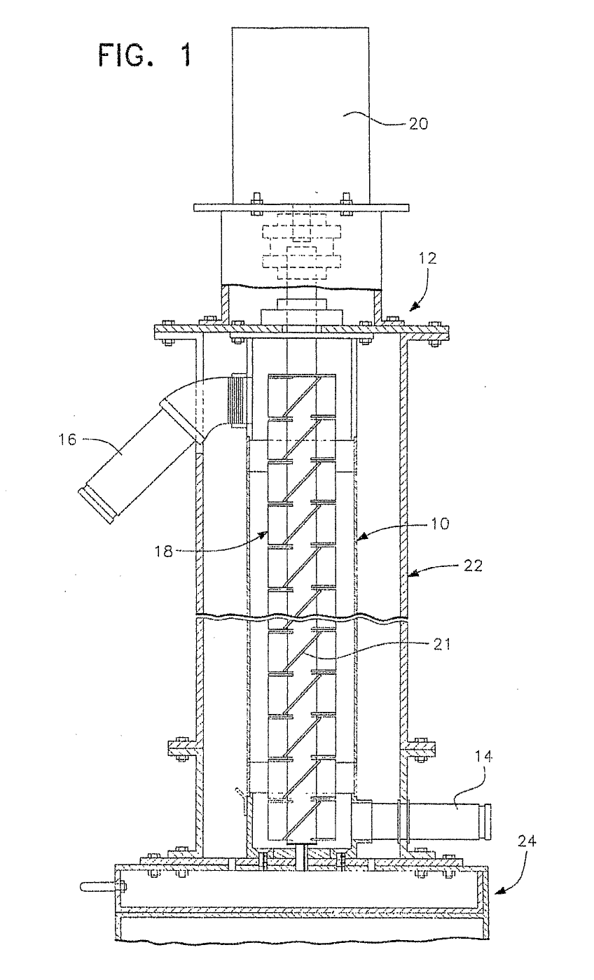

Referring specifically to FIG. 1 of the drawings, the polymer pellet and micropellet dryer screen of the present invention is generally designated by reference numeral 10. FIG. 1 discloses the association of the pellet screen 10 within one typical centrifugal pellet dryer generally designated by reference numeral 12 that is disclosed in detail in U.S. Pat. No. 6,237,244. The centrifugal pellet dryer 12 includes a water and pellet slurry inlet 14 at its lower end and a dried pellet outlet 16 at its upper end. Inlet 14 communicates with the interior of the screen 10 near its lower end and the outlet 16 communicates with the screen 10 near its upper end. A rotor generally designated by reference numeral 18 is rotatably positioned within the screen 10 and is driven by a motor 20 drivingly connected to the rotor, shown at its upper end in the configuration of FIG. 1. The rotor 18 includes inclined blades 21 rotating within the screen 10 to move the water and pellet slurry upwardly and to move the pellets and water radially outwardly into impacting engagement with the interior of the screen 10. The impact against the interior of the screen 10 causes water to be discharged outwardly of the screen into a housing generally designated by reference numeral 22 for downward gravity discharge, such as into a water tank generally designated by reference numeral 24.

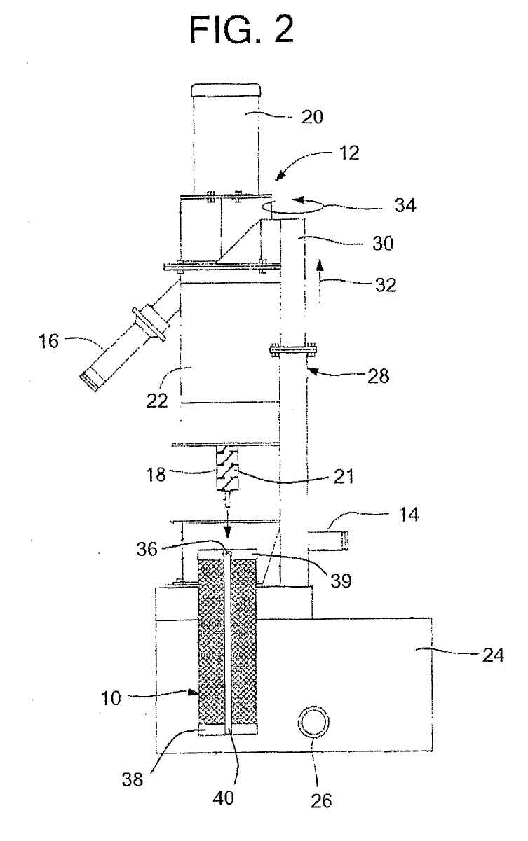

FIG. 2 illustrates additional details including the lifting and swivel operations of the dryer illustrated in FIG. 1. The support tube 28 facilitates raising the housing 22 directionally as indicated by the arrow 32 for removal of the screen 10 from around the rotor 18. The structure swivels by rotation of the movable telescopic tube 30 as indicated by the directional arrow 34. Orifice 26 facilitates discharge of the water from the water tank as required. The details of the structure and operating mechanisms follow that disclosed in the aforementioned U.S. Pat. No. 6,237,244.

The screen 10 as shown in FIG. 2 in this application of the current invention is a self-supported cylindrical structure which is delineated by a peripheral wall, at both the lower end 38 and upper end 39 of the screen 10. Optionally, one or more structural supports 40 are attached to each of the peripheral end walls 38 and 39, respectively. Affixed to the upper peripheral wall 39 or optionally attached to one structural support 40 is an upwardly extending hook 36 which is oriented diametrically and opens peripherally outward to attach to the support structure mechanistically analogous to that described in U.S. Pat. No. 6,237,244 referenced previously.

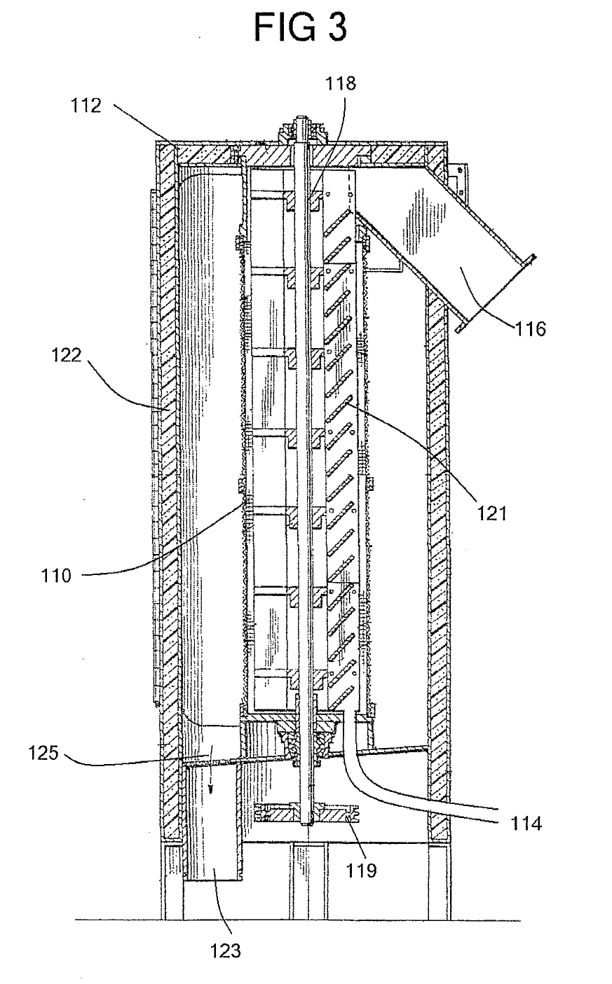

Referring next to FIG. 3, the polymer pellet and micropellet dryer screen generally designated by reference numeral 110 is another embodiment of the present invention. The centrifugal pellet dryer associated with screen 110 of this embodiment is generally designated by reference numeral 112 and is disclosed in detail in U.S. Pat. No. 5,265,347. The centrifugal pellet dryer 112 includes a simulated water and pellet slurry inlet 114 at its lower end and a dried pellet outlet 116 at its upper end. Inlet 114 communicates with the interior of the screen 110 near its lower end and the outlet 116 communicates with the screen 110 near its upper end. A rotor 118 is rotatably positioned within the screen 110 and is driven by a motor, not shown, drivingly connected to the rotor via a belt affixed to the pulley 119. The rotor 118 includes inclined blades 121 rotating within the screen 110 to move the water and pellet slurry in a manner similar to that previously described for FIG. 1. Water which has been removed from the pellets flows out of the housing 122 through the drain pipe 123 directionally as indicated by arrow 125.

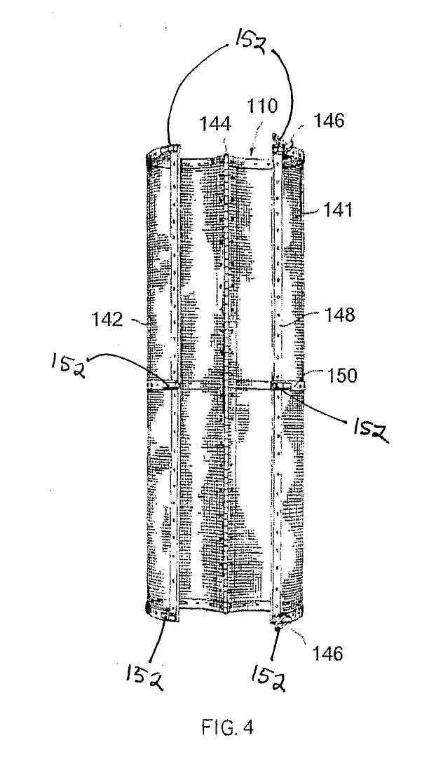

As shown in FIG. 4, the screen 110 in this embodiment of the current invention is self-supporting and consists of two semi-cylindrical structures 141 and 142 hingedly connected by a vertical hinge 144. The screen 110 is supported with peripheral edge frame members 148 and a central belt frame member 150 which maintain its shape and configuration. Once placed in the centrifugal pellet dryer shown in FIG. 3, the semi-cylindrical elements 141 and 142 are connected to each other utilizing quick-acting latches 152. Construction details are similar to those described in the aforementioned U.S. Pat. No. 5,265,347.

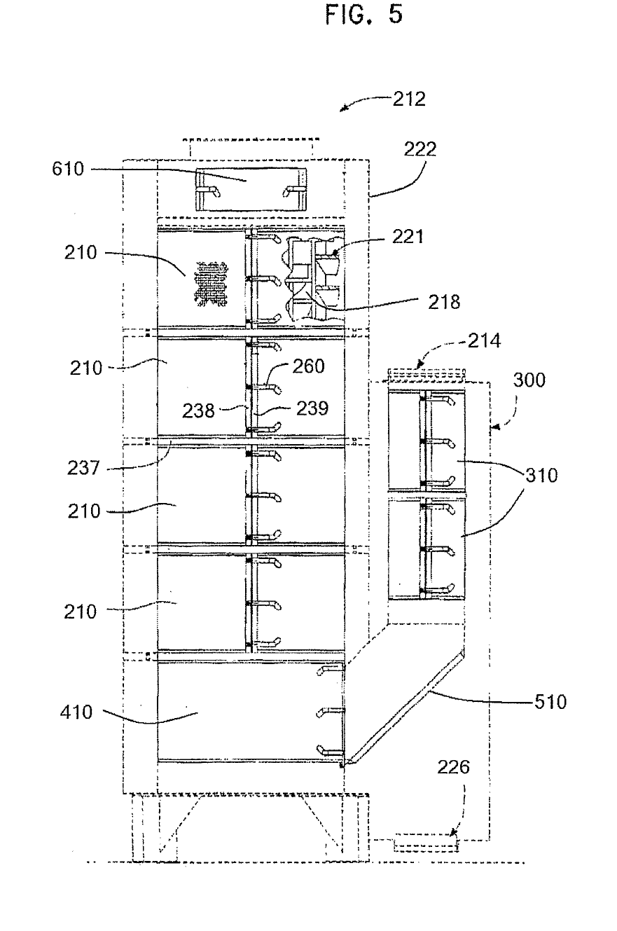

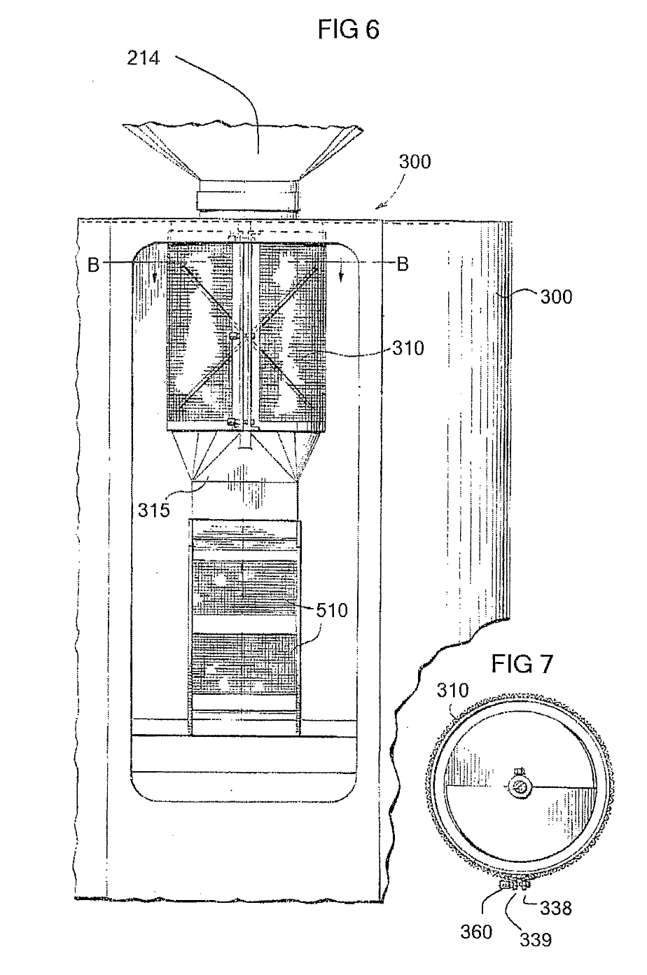

A further embodiment of the present invention finds application to dryers incorporating screens as exemplified in FIG. 5 and similar in design to FIG. 1 of the previously cited U.S. Pat. No. 6,739,457. Multiple screen sections within the centrifugal pellet dryer in this embodiment are designated by reference numeral 210. The centrifugal pellet dryer 212 includes a water and pellet slurry inlet 214 at the upper end of an auxiliary dewatering device generally designated as 300, and a dried pellet outlet, not shown, at the upper end of the dryer. Inlet 214 communicates with the interior of the dewatering screen or screens 310 which further communicate with the feed screen 510 oriented at an angle to convey the pellets with significantly reduced water content into the lower end of the base screen 410 of the centrifugal dryer. The excess water removed through the dewatering screen(s) 310 and feed screen 510 passes through outlet 226. Details of the design follow the aforementioned U.S. Pat. No. 4,447,325 and are further illustrated in FIGS. 6 and 7 of the accompanying drawings, which are similar to FIGS. 2 and 3, respectively, of U.S. Pat. No. 4,447,325. A flange 315 (see FIG. 6) connects the dewatering screen 310 directly to the feed screen 510. Details of the dewatering screen 310 as viewed across the B-B line are reflected in FIG. 7 wherein the screen end angles 338 and 339 are joined by the flange connector 360.

The significantly dewatered pellets feed into the lower portion of the screen section 410 and through screen sections 210, which may be the same or different dimensions than is 410, and subsequently to the outlet, not shown, which communicates with the uppermost screen section 210 near its upper end. A rotor 218 is rotatably positioned within the screen sections 210 and 410 and is driven by a motor, not shown, drivingly connected to the rotor via a belt affixed to the pulley, also not shown. The rotor 218 includes inclined blades 221 rotating within the screen sections 210 and 410 to move the water and pellet slurry in a manner as previously described with respect to FIG. 1. Water which has been removed from the pellets flows out of the housing 222 through the drain pipe 226.

The screens 210 and 410 are fixed into position by a clamp or clamps 260 which affix the screen end angles, 238 and 239, to each other. The screen sections are held in place, vertically aligned and interconnected by ring supports 237. One, two, three, or more screen sections may be fixedly attached vertically as necessitated by production rates and product moisture level reduction specifications.

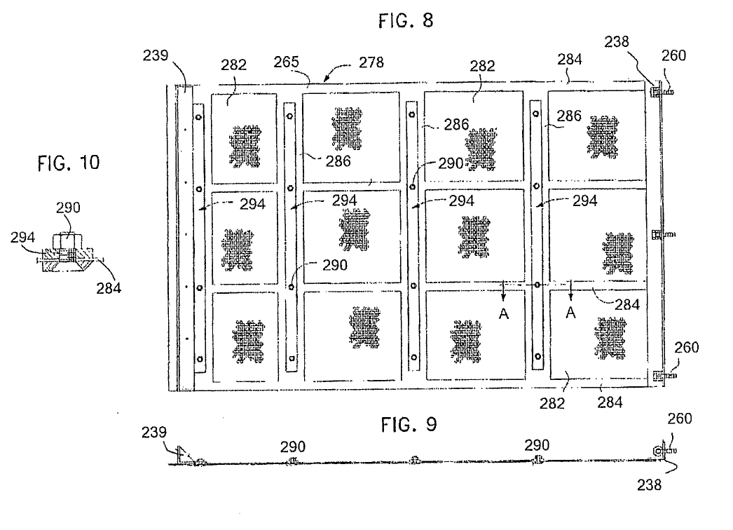

FIG. 8 illustrates an alternate screen assembly 265 wherein the screens are supported by deflector bars 294 held in place by bolt assemblies 290 affixed diametrically to solid support structures 286 across the width of the screen assembly 265. Structural screen assembly supports 284 traverse the screen along its length similarly. These supports 284 and 286 segmentalize the screen area 282 in approximately equal proportions. Details of the construction of this screen are delineated in the aforementioned U.S. Pat. No. 6,739,457. An edge view, FIG. 9, and a detailed bolt assembly, FIG. 10, are shown diagramatically for the screen assembly 265.

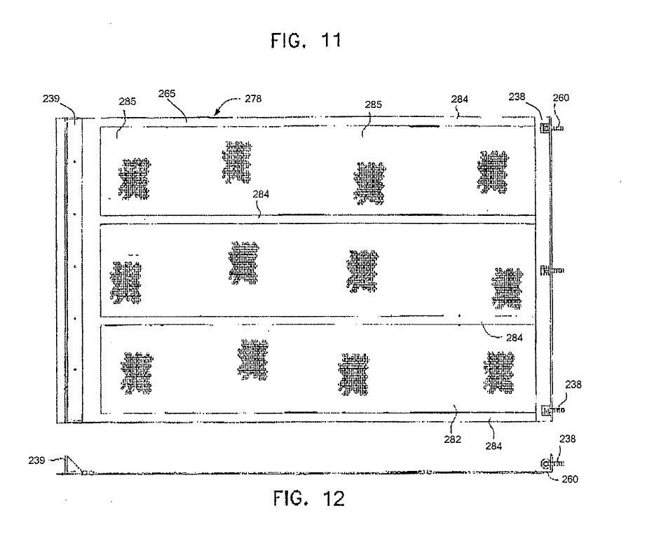

Alternatively, screens 210, 310, and/or 410 may have an overall construction as illustrated in FIGS. 11 and 12. The screen construction shown in FIGS. 11 and 12 differs from that shown in FIGS. 8-10 in that the FIGS. 11 and 12 construction does not contain the deflector bars 294, and consequently no bolt assemblies 290, nor do they require the structural screen assembly supports 286 across the width of the screen.

A port screen 610 is similarly affixed in place and is positioned nearest the effluent opening, not shown, in FIG. 5 and described in detail in the aforementioned U.S. Pat. No. 6,739,457. Alternatively, a port screen may be at the base of the screen chamber, below screen section 410 in FIG. 5, and positionally not indicated but included herein by way of reference.

The cylindrical screens 10, hinged screens 110, screen panels 210 and 410, dewatering screens 310, feed screens 510, and port screens 610 are all dryer screen embodiments which can be made according to the present invention. Compositionally and structurally, they may be the same or different from other screen structures in a particular dryer assembly.

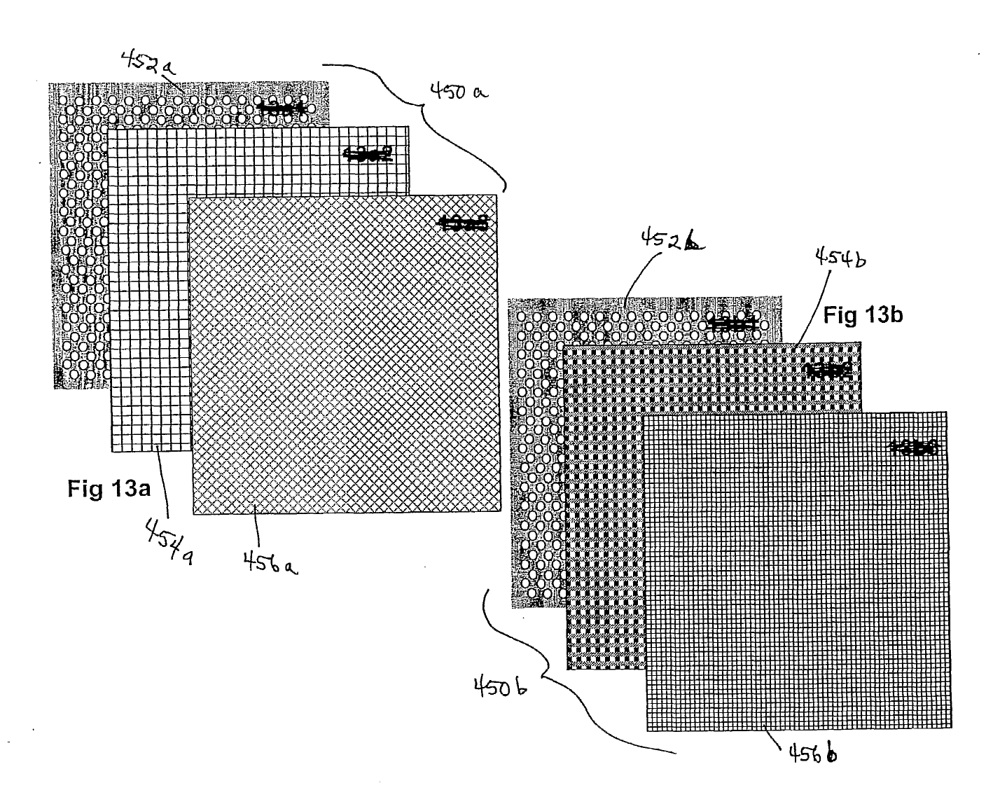

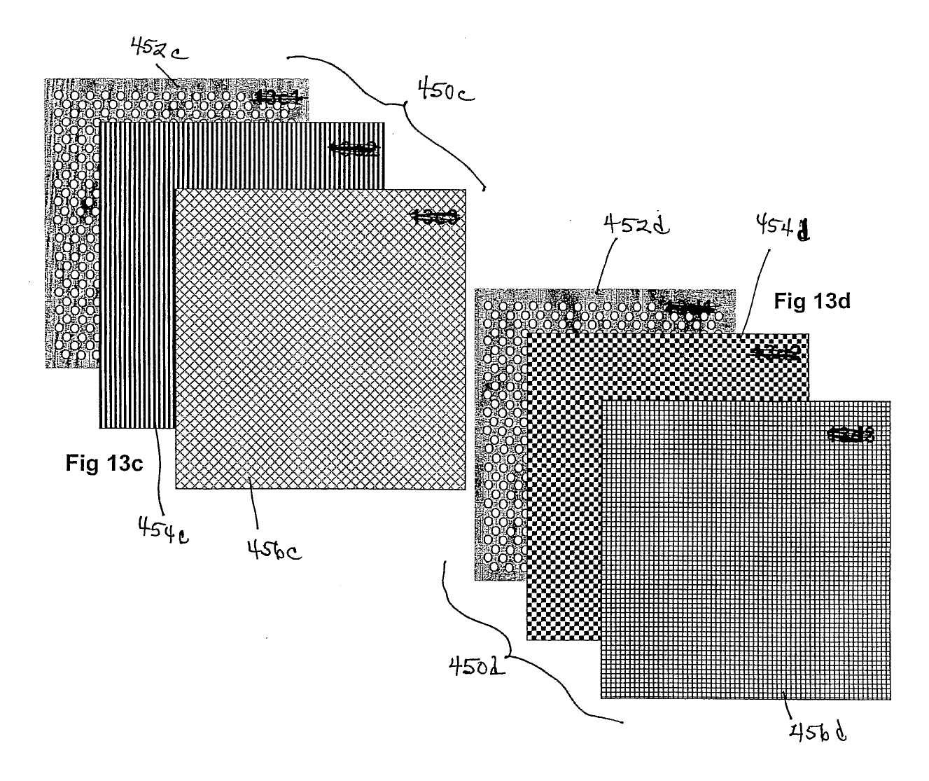

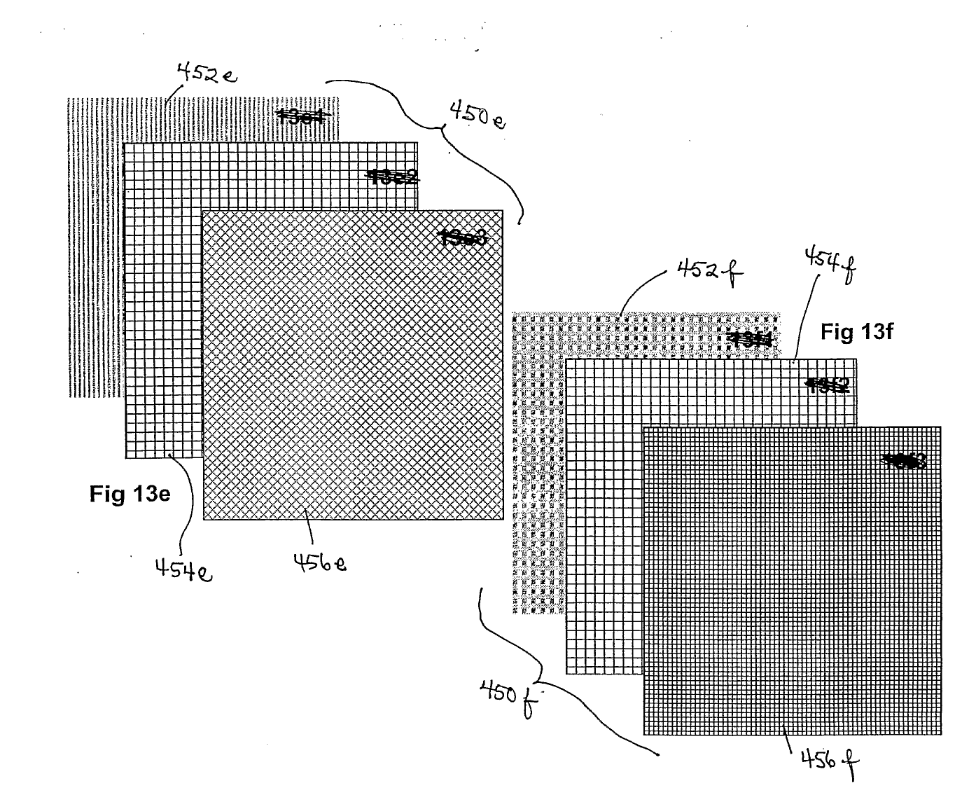

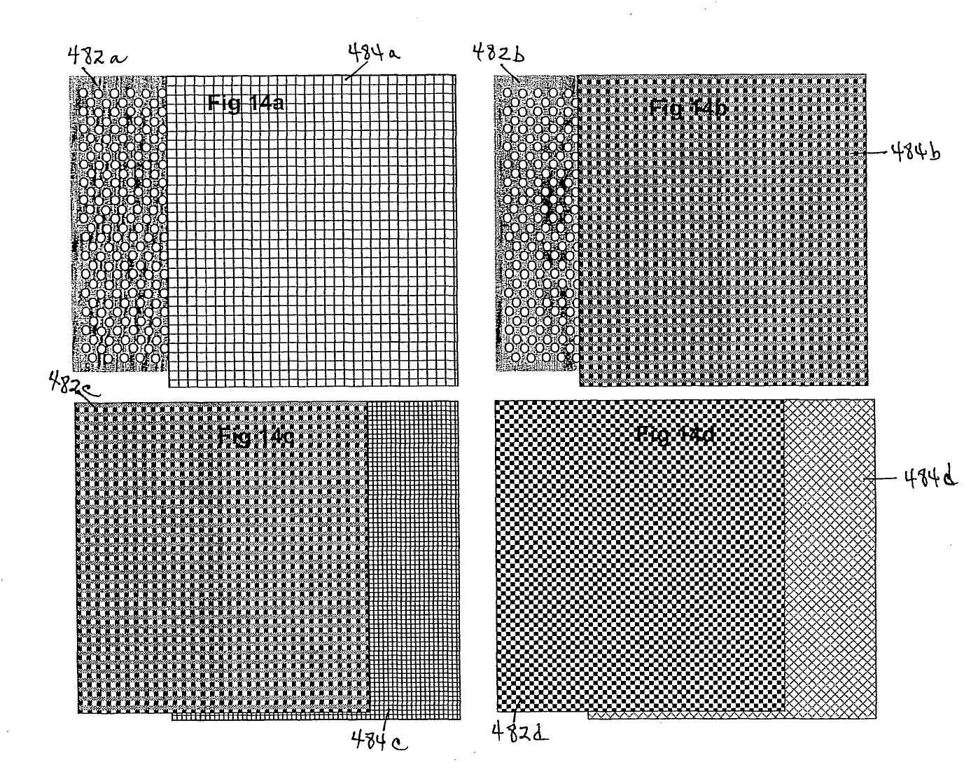

In accordance with the present invention, the dryer screens are compositionally two or more layers functionally consisting of an outer support screen and an inner screen which accomplishes the effective drying of the pellets and micropellets. Additionally one or more screen layers may be sandwiched between the outer support screen and the inner screen depending upon the particular application. Exemplary embodiments of the present invention are shown in FIGS. 13a through 13f for three-layer screens, and in FIGS. 14a through 14d for two-layer screens.

The three-layer dryer screen assemblies illustrated in FIG. 13a through 13f are generally designated by reference numeral 450a through 450f, respectively. They include an outer support screen, identified by 452a through 452f, respectively, which provides structural support to the screen assembly. The outer support screens 452a-452f may be composed of molded plastic or wire-reinforced plastic and compositionally may be polyethylene, polypropylene, polyester, polyamide or nylon, polyvinyl chloride), polyurethane, or similarly inert material which capably maintains its structural integrity under chemical and physical conditions anticipated in the operation of centrifugal pellet dryers. Preferably the outer support screens 452a-452f are a metal plate of suitable thickness to maintain the structural integrity of the overall screen assembly 450 and flexible enough to be contoured, exemplarily cylindrically, to fit tightly and positionally in the appropriate centrifugal pellet dryer. The metal plate is preferably 18 gauge to 22 gauge and most preferably 20 gauge in thickness. The metal may compositionally be aluminum, copper, steel, stainless steel, nickel steel alloy, or similarly non-reactive material inert to the components of the drying process. Preferably the metal is stainless steel and most preferably is Grade 304 or Grade 316 stainless steel as necessitated environmentally by the chemical processes undergoing the drying operation.

The metal plate may be pierced, punched, perforated, or slotted to form openings which may be round, oval, square, rectangular, triangular, polygonal, or other dimensionally equivalent structure to provide open areas for separation and subsequent drying. Preferably the openings are round perforations and geometrically staggered to provide the maximum open area while retaining the structural integrity of the outer support screen. The round perforations are preferably at least 0.075 inches in diameter and are positionally staggered to provide an open area of at least 30%. More preferred is an open area geometric orientation such that the effective open area is 40 percent or more. Most preferred are round perforations having a diameter of at least 0.1875 inches which are positionally staggered to achieve an open area of 50 percent or more.

Alternatively, the outer support screen may be an assembled structure or screen composed of wires, rods, or bars, stacked angularly or orthogonally, or interwoven, and welded, brazed, resistance welded or otherwise permanently adhered in position. The wires, rods, or bars may be plastic or wire-reinforced plastic compositionally similar to the molded plastic described above for outer support screens 452a-452f or may be metal, similarly and compositionally delineated above also for the outer support screens 452a-452f, and may be geometrically round, oval, square, rectangular, triangular or wedge-shaped, polygonal or structurally similar. The wires, rods, or bars across the width or warp of the screen may be the same or different dimensionally as the wires, rods, or bars longitudinally contained as the weft, shute, or otherwise known to those skilled in the art.

Preferably the wires, rods, or bars are a minimum of 0.020 inches in the narrowest dimension, more preferably are at least 0.030 inches in the narrowest dimension, and most preferably are about 0.047 inches in the narrowest dimension. Open areas are dimensionally dependent on the proximal placement of adjacent structural elements and are positionally placed so as to maintain a percent open area of at least about 30 percent, more preferably above about 40 percent, and most preferably about 50 percent or greater.

FIGS. 13a-f show perforated outer plates identified as 452a-452d, a slotted or pierced outer plate identified as 452f and a structural assembly of resistance-welded round rods and wedge-shaped rods identified as 452e. Outer support screens 482a-d are similarly illustrated for 2-layer screens 480a-d of the present invention in FIGS. 14a-d wherein the outer support screen is the leftmost element in the drawing views. Outer support screens 482a and 482b are in the form of perforated plates, screen 482c is a slotted screen and screen 482d is a pierced screen.

The optional middle screen or screens and the inner screen are structurally similar to that described herein for the outer support screen. Dimensionally and compositionally the screens in the respective layers may be similar or different. The percent open area of the respective screens may be similar or different wherein lesser percent open area will reduce the effective open area of the screen and the least percent open area will be the most restrictive and therefore the delimiting percent open area for the screen assembly. The middle screens are identified in FIGS. 13a-f by numerals 454a-f, respectively. They include, by way of example, woven wire screens 454a, 454e and 454f, slotted screen 454b resistance welded bar screen 454c and pierced screen 454d. Exemplary inner screens are similarly illustrated in FIGS. 13 and 14 by numerals 456a-f and 484a-d, respectively. The orientation of any screen relative to other layers of the assembly as well as the dimensions and structural composition of the screens may be similar or different as shown by way of example in FIG. 13f with a reduced mesh size for inner screen 456f relative to middle screen 454f in FIG. 13e with the angle of orientation of inner screen 456e rotated relative to middle screen 454e.

Preferably the middle screen 454a-f is a woven wire screen which may be in a square, rectangular, plain, Dutch or similar weave wherein the warp and weft wire diameters may be the same or different dimensionally or compositionally. More preferably the middle layer is a plain square or rectangular weave wire screen wherein the warp and weft wires are similar compositionally and dimensionally and the percent open area is 30 percent or greater. Even more preferably the middle layer screen is 30 mesh grade 304 or grade 316 stainless steel wherein the warp and weft wires are of a size to allow at least 30 percent open area and most preferably are 50 percent open area or more. Multiple middle screens are included within the embodiments of the current invention and may be similar or different than another middle layer screen structurally and compositionally.

The inner screen 456a-f and 484a-e preferably is a woven wire screen which may be in a square, rectangular, plain, Dutch or similar weave wherein the warp and weft wire diameters may be the same or different dimensionally or compositionally. More preferably the inner screen is a plain square or rectangular weave wire screen wherein the warp and weft wires are similar compositionally and dimensionally and the open area is 30 percent or greater. Even more preferably, the inner layer screen is plain square or rectangular 30 mesh or larger mesh grade 304 or grade 316 stainless steel wherein the warp and weft wires are of a size to allow at least 30 percent open area and most preferably are 50 percent open area or more. Still more preferred is an inner screen of a plain square or rectangular weave of 50 mesh or greater mesh, with a percent open area of 50 percent or greater oriented similarly to the middle screen orientation, when a middle screen is present in the structural assembly. Most preferred is a rectangular weave of 50 mesh or greater mesh where the warp and weft are compositionally and structurally similar, allowing an open area of 50 percent or greater. As is readily apparent to those skilled in the art, the higher the mesh the smaller the diameter of the pellet, and preferably the micropellet, which will be retained by the screen and ultimately dried through the drying process.

Essentially, the pellet and micropellet screens of the present invention, such as screens 10, 110, 210, 310, 410, 510 and 610, can be utilized in combination with the components of the centrifugal dryers as described above and shown in the aforementioned U.S. patents or in combination with any other centrifugal pellet dryer which can accommodate the screen of the present invention and serve to dry pellets, especially polymer micropellets.

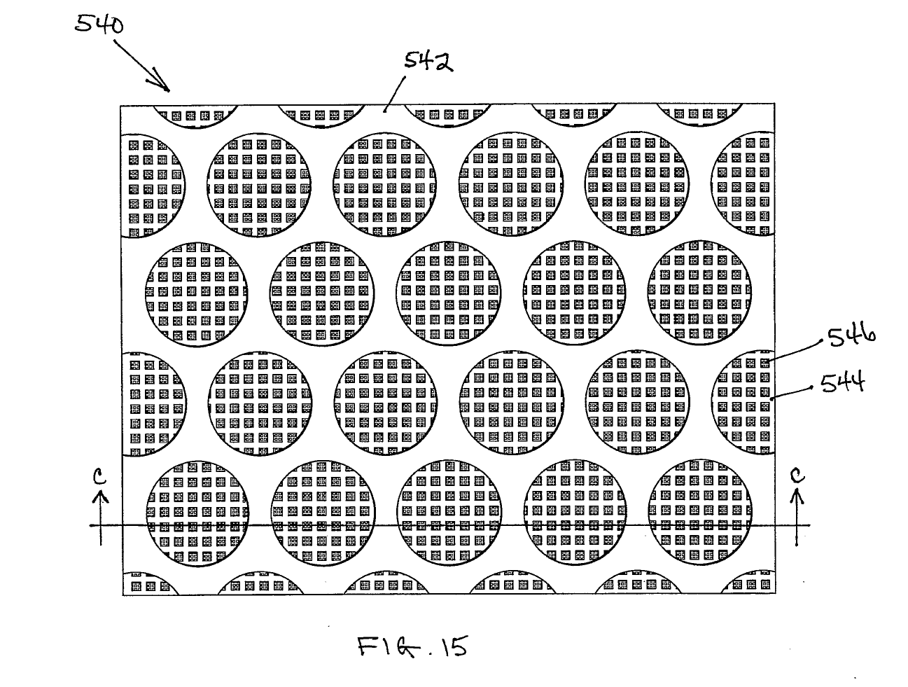

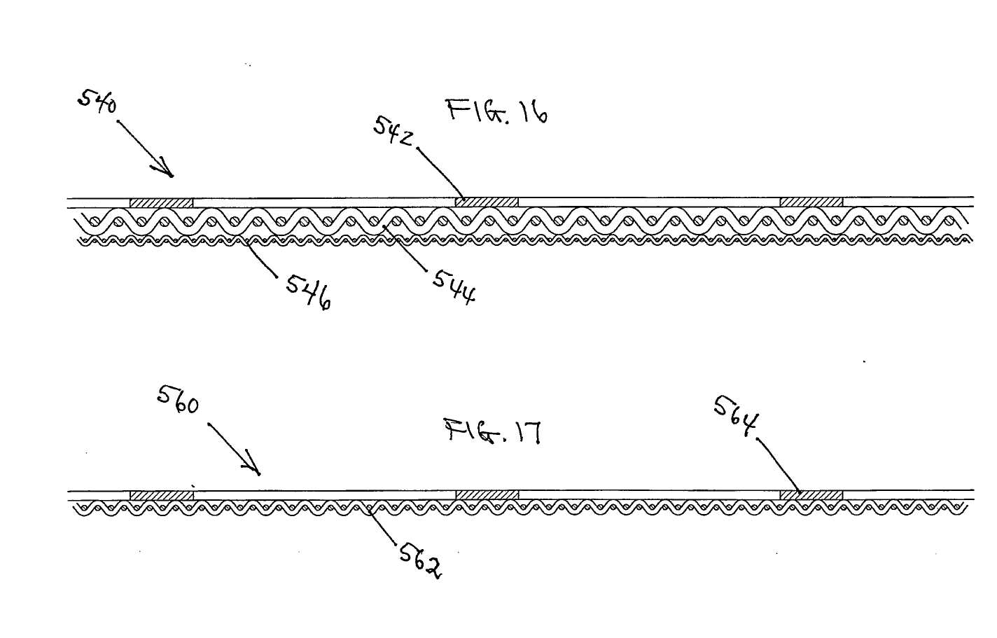

FIG. 15 schematically illustrates a three layer screen 540 in accordance with the present invention as viewed through the perforated outer support screen 542 to the plain square woven middle screen 544 to the larger mesh (smaller openings) plain square woven inner screen 546. FIG. 16 shows this structure in cross-section at line C-C in FIG. 15. A comparable two layer screen 560 is illustrated in FIG. 17 with a plain square woven inner screen 562 bonded to perforated outer screen 564.

The component layers of the multi-layer screens of the present invention are in intimate contact and may be bonded together. Preferably the individual layers are thermally bonded, chemically bonded, soldered, spot-welded, brazed, resistance welded, diffusion bonded or sintered. The preferred configurations of the screen are most preferably diffusion bonded or sintered at all contact points between each of the component screens. The screens may be rolled, drawn, calendered or otherwise compressionally altered as is understood by those skilled in the art. Preferably the screens of the preferred embodiments are calendered.

The multi-layer dryer screens of the present invention have been specifically described for 3-layer and 2-layer embodiments. It is believed that the middle layer in the 3-layer embodiment actually increases the open area of the dryer screen and serves as a drainage field for the water escaping through openings of the inner screen, thus providing for more rapid removal of the water and moisture during the drying operation. In addition, those skilled in the art will readily appreciate that 3-layers and 2-layers are preferred for the multi-layer screens of the present invention, but additional layers beyond three may be possible, such as four layers, or more if desired.

While the centrifugal pellet dryer screens of the present invention have been described as especially useful for drying polymer micropellets, the dryer screen of the present invention can be useful in drying other size and type pellets particularly where the pellets being dried have a tendency to band and circulate around the screen, rather than moving axially up the screen towards the dryer exit, or otherwise tend to plug the screen holes. Exemplary of the materials for which the dryer screens of the present invention can be useful are filled or unfilled polyethylene (PE) including low density (LDPE), linear low density (LLDPE), medium density polyethylene (MDPE), high density polyethylene (HDPE), ultrahigh molecular weight polyethylene (UHMWPE), polypropylene including amorphous and crystalline, acrylonitrile-butadiene-styrene (ABS), styrene-acrylonitrile (SAN), polystyrene, polyesters, polyamides or nylon, polycarbonates, polyacrylics, polyacetals, polyurethanes, expandable polystyrene (EPS), expandable polyethylene (EPE) and expandable polypropylene (EPP), thermoplastics including elastomers and thermoplastic rubbers in general regardless of how they are made.

The foregoing is considered as illustrative only of the principals of the invention. Further, numerous modifications and changes will readily occur to those skilled in the art. Therefore, it is not intended to limit the invention to the exact construction and operation shown and described, and all suitable modifications and equivalents may be resorted to, falling within the scope of the invention.

What is claimed:

1. A screen for use in association with a centrifugal pellet dryer when used to dry polymer pellets or micropellets introduced into the dryer as a slurry of water and pellets, said screen comprising a shape sustaining outer member having relatively larger openings and at least one inner screen conforming with and attached to an inner surface of said outer member having closely spaced relatively smaller openings small enough to retain said polymer pellets or micropellets interiorly of the inner screen and permitting passage of water through the inner screen and outer member during operation of the centrifugal pellet dryer.

2. The dryer screen as claimed in claim 1, wherein said
closely spaced openings maintain a high open area in the inner screen to enable increased water flow through the screen and to reduce plugging of said inner screen openings by retained pellets or micropellets.

3. The dryer screen as claimed in claim 1, wherein said outer member is a perforated sheet formed into a generally cylindrical shape and said inner screen is a wire mesh screen.

4. The dryer screen as claimed in claim 3, wherein said
wire mesh inner screen is bonded to said outer member and provides a rough surface for engagement by the pellets or micropellets to resist banding and facilitate upward and radial movement of the pellets or micropellets within the screen by rotation of a rotor during operation of the dryer.

5. The dryer screen as claimed in claim 1, wherein said closely spaced openings in the inner screen and the openings in the outer member form a open area for said dryer screen of at least about 30% of the surface area of the screen.

6. The dryer screen as claimed in claim 3, wherein said
inner wire mesh is a woven wire mesh screen bonded to an inner surface of said outer member.

7. The dryer screen as claimed in claim 6, wherein said
woven wire mesh screen is diffusion bonded substantially throughout its contact surfaces to inner contact surfaces of said outer member.

8. The dryer screen as claimed in claim 1, wherein the outer ends of said screen include unperforated generally cylindrical reinforcing bands.

9. The dryer screen as claimed in claim 3, wherein a second wire mesh screen is sandwiched between and diffusion bonded to said inner wire mesh screen and said generally cylindrical perforated outer member.

10. The dryer screen as claimed in claim 9, wherein said second wire mesh screen has openings larger than the closely spaced openings of said inner wire mesh screen.

11. A centrifugal pellet dryer for drying polymer pellets and micropellets which comprises a housing, a cylindrical screen mounted generally vertically in said housing, a water and pellet slurry inlet adjacent a bottom of said cylindrical screen and a dried pellet outlet adjacent a top of said cylindrical screen, and a driven rotor to direct said pellets entering said inlet outwardly towards said cylindrical screen and upwardly towards said outlet, said generally cylindrical screen being multi-layered and having at least a generally cylindrical shape sustaining outer member with relatively larger openings and an inner screen conforming with and in contact with an inner surface of said outer member, said inner screen having relatively smaller openings of a size sufficient to retain said pellets interiorly of the screen and permitting passage water through the inner screen and outer member during operation of the centrifugal pellet dryer.

12. The centrifugal pellet dryer as claimed in claim 11, wherein said outer member is a perforated sheet and said inner screen is a wire mesh screen.

13. The centrifugal pellet dryer as claimed in claim 11, wherein said generally cylindrical screen has an open area of at least about 30% to enable increased water flow through the screen and to reduce plugging of said inner screen openings by retained pellets.

14. The centrifugal pellet dryer as claimed in claim 12, wherein said wire mesh inner screen is 50 mesh or higher mesh.

15. The centrifugal pellet dryer as claimed in claim 11, wherein said inner screen provides a rough surface for engagement with said pellets to resist banding and facilitate upward and radial movement of said pellets within said screen by rotation of said rotor during operation of the dryer.

16. The centrifugal pellet dryer as claimed in claim 11, wherein ends of said generally cylindrical screen include solid generally cylindrical bands for reinforcing said screen and facilitating attachment of said screen in said dryer.

17. The centrifugal pellet dryer as claimed in claim 11, wherein an outer surface of said inner screen is bonded to an inner surface of a middle screen and an outer surface of said middle screen is bonded to an inner surface of said cylindrical outer member.

18. The centrifugal pellet dryer as claimed in claim 17, wherein all of said surfaces are sintered or diffusion bonded substantially throughout their contact surfaces.

19. A generally cylindrical screen for a centrifugal pellet dryer when used to dry polymer pellets and micropellets introduced into the dryer as a slurry of water and pellets, said generally cylindrical screen comprising three layers, including a generally cylindrical shape sustaining outer member having relatively larger openings, a middle screen whose outer surface is attached substantially throughout its contact surfaces to inner contact surfaces of said outer member, and an inner screen conforming with and having its outer surface attached substantially throughout its contact surfaces to inner contact surfaces of said middle screen, said inner screen having openings smaller than openings of said middle screen and sufficient to retain said polymer pellets or micropellets interiorly of the inner screen while permitting passage of water through the inner screen, middle screen and outer member during operation of the centrifugal pellet dryer.

20. The dryer screen as claimed in claim 19, wherein said dryer screen has an open area of at least about 30%.

21. The dryer screen as claimed in claim 20, wherein said outer member is a perforated sheet formed into said generally cylindrical shape, and said middle screen and inner screen are both wire mesh screens.
